(19) United States
(12) Patent Application Publication
(10) Pub. No.: US 2025/0187514 A1
(43) Pub. Date: Jun. 12, 2025

(54) VEHICLE STEERING APPARATUS

(71) Applicant: Panasonic Automotive Systems Co., Ltd., Kanagawa (JP)

(72) Inventors: Kanji MUTO, Kanagawa (JP); Tsuyoshi TANAKA, Kyoto (JP); Kensuke MARUYA, Kanagawa (JP); Yuya YAMASAKI, Fukuoka (JP); Masaki TADA, Osaka (JP)

(21) Appl. No.: 18/952,590

(22) Filed: Nov. 19, 2024

(30) Foreign Application Priority Data
Dec. 7, 2023 (JP) 2023-207029

(51) Int. Cl. B60N 3/00; B60R 25/01; B60R 25/24; B62D 1/04

(52) U.S. Cl. CPC B60N 3/005; B60R 25/01; B60R 25/24; B62D 1/04

(57) ABSTRACT

A vehicle steering apparatus includes: a spoke of a steering wheel of a vehicle; and a pair of grips, one of which is disposed on the left portion of the spoke and another of which is disposed on the right portion of the spoke, each shaped in an arc or straight line. The pair of grips are rotatable relative to the spoke.

### CROSS REFERENCE TO RELATED APPLICATIONS

The present application is based on and claims priority of Japanese Patent Application No. 2023-207029 filed on Dec. 7, 2023.

### FIELD

The present disclosure relates to a vehicle steering apparatus provided on a steering wheel of a vehicle.

### BACKGROUND

Patent Literature (PTL) 1 discloses a vehicle steering apparatus that includes a lateral movement mechanism for moving a steering wheel between an operative position set forward of the driver's seat and an evasive position set forward of the passenger seat, and a controller to control the operation of the lateral movement mechanism. In this vehicle steering apparatus, switching between manual steering and autonomous steering is possible. When switching from manual steering to autonomous steering, the controller moves the steering wheel from the operative position to the evasive position, thereby expanding the space in front of the driver's seat.

### CITATION LIST

### Patent Literature

PTL 1: Japanese Unexamined Patent Application Publication No. 2020-142539

### SUMMARY

However, the vehicle steering apparatus according to PTL can be improved upon.

In view of this, the present disclosure provides a vehicle steering apparatus capable of improving upon the above related art.

A vehicle steering apparatus according to one aspect of the present disclosure includes: a spoke of a steering wheel of a vehicle; and a pair of grips, one of which is disposed on a left portion of the spoke and another of which is disposed on a right portion of the spoke, each shaped in an arc or straight line. The pair of grips are rotatable relative to the spoke.

### Advantageous Effects

The vehicle steering apparatus according to the present disclosure is capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a perspective view illustrating a vehicle steering apparatus including a pair of automatically rotatable grips.

FIG. 2 is a block diagram illustrating a vehicle steering apparatus including a pair of automatically rotatable grips.

FIG. 3 is a perspective view illustrating different states of a table in a vehicle steering apparatus including a pair of automatically rotatable grips.

FIG. 4 is a flowchart illustrating a vehicle steering apparatus including a pair of automatically rotatable grips.

FIG. 5 is a block diagram illustrating a vehicle steering apparatus including a pair of manually rotatable grips.

FIG. 6 is a flowchart illustrating a vehicle steering apparatus including a pair of manually rotatable grips.

FIG. 7 is a perspective view illustrating a vehicle steering apparatus including an automatically rotatable steering wheel.

FIG. 8 is a block diagram illustrating a vehicle steering apparatus including an automatically rotatable steering wheel.

FIG. 9 is a flowchart illustrating a vehicle steering apparatus including an automatically rotatable steering wheel.

FIG. 10 is a block diagram illustrating a vehicle steering apparatus including a manually rotatable steering wheel.

FIG. 11 is a flowchart illustrating a vehicle steering apparatus including a manually rotatable steering wheel.

FIG. 12 is a block diagram illustrating a vehicle steering apparatus according to another variation.

FIG. 13 is another block diagram illustrating a vehicle steering apparatus according to another variation.

### DESCRIPTION OF EMBODIMENT(S)

Hereinafter, one or more embodiments of the present disclosure will be described in detail with reference to the drawings.

The embodiments described below each illustrate a general or specific example of the present disclosure. The numerical values, shapes, materials, elements, the arrangement and connection of the elements, etc., shown in the following embodiments are mere examples, and therefore do not limit the scope of the present disclosure. Accordingly, among the elements in the following embodiments, those not recited in any of the independent claims are described as optional elements.

Note that the figures are schematic illustrations and are not necessarily precise depictions. In the figures, elements that are the same share the same reference signs.

In the following embodiments, expressions such as “rod-shaped” and “horizontal direction” are used. For example, the terms “rod-shaped” and “horizontal direction” do not only refer to exactly rod-shaped and precisely horizontal, but also to shapes substantially similar to a rod and directions substantially similar to the horizontal direction, that is, including variations of about a few percent. Moreover, the terms “rod” and “horizontal direction” refer to rods and horizontal directions to the extent that the advantageous effects of the present disclosure can be achieved. The same applies to other expressions using “shape” or “direction”.

### Embodiment

### Configuration and Function in Automatic Mode

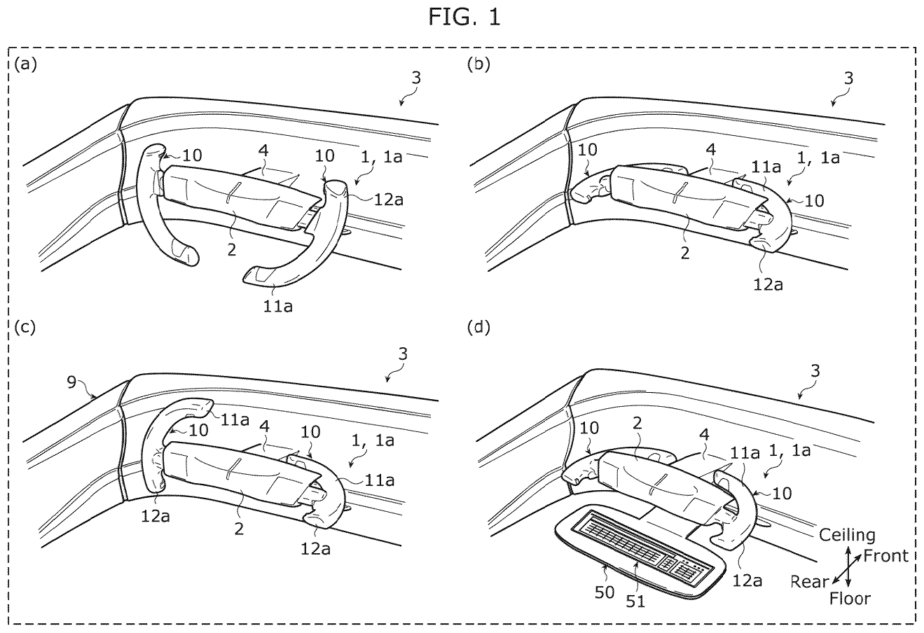

First, vehicle steering apparatus 1 according to the present embodiment will be described with reference to FIG. 1 through FIG. 3.

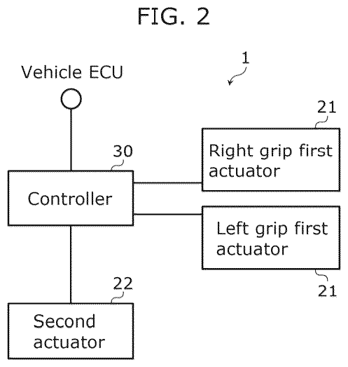

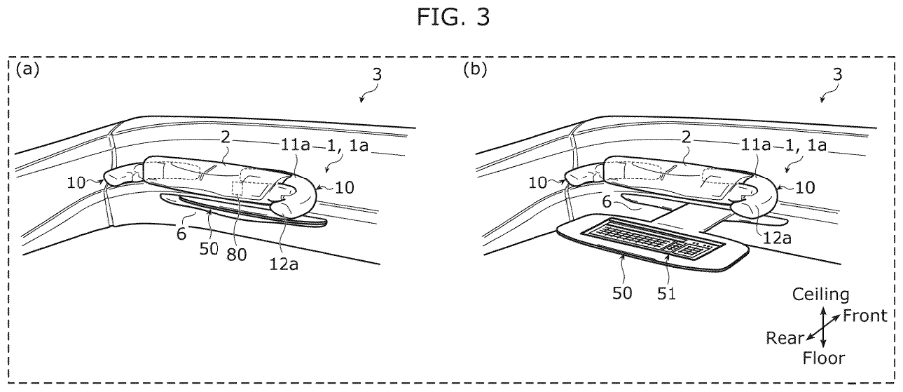

FIG. 1 is a perspective view illustrating vehicle steering apparatus 1 including a pair of automatically rotatable grips 10. In FIG. 1, (a) illustrates vehicle steering apparatus 1 when the steering position during driving is in the neutral position. In FIG. 1, (b) illustrates vehicle steering apparatus 1 with the pair of grips 10 laid flat horizontally. In FIG. 1, (c) illustrates vehicle steering apparatus 1 with grip 10 adjacent to door 9 of vehicle 3 adjacent to vehicle steering apparatus 1 standing vertically, and the other grip 10 laid flat horizontally. In FIG. 1, (d) illustrates vehicle steering apparatus 1 with the pair of grips 10 laid flat horizontally and table 50 deployed. FIG. 2 is a block diagram illustrating vehicle steering apparatus 1 including a pair of automatically rotatable grips 10. FIG. 3 is a perspective view illustrating different states of table 50 in vehicle steering apparatus 1 including a pair of automatically rotatable grips 10. In FIG. 3, (a) illustrates vehicle steering apparatus 1 with the pair of grips 10 laid flat horizontally, and table 50 stored in a storage space in column cover 6 that covers the bottom of steering column 4. In FIG. 3, (b) illustrates vehicle steering apparatus 1 with the pair of grips 10 laid flat horizontally, and table 50 deployed from the storage space in column cover 6.

FIG. 1 and the like illustrate an example in which vehicle steering apparatus 1 is provided in vehicle 3 in which the driver's seat is on the left hand side relative to the direction of travel. Note that vehicle steering apparatus 1 according to the present disclosure may be provided in vehicle 3 in which the driver's seat is on the right hand side relative to the direction of travel.

Vehicle steering apparatus 1 is an apparatus capable of applying a steering angle to the steered wheels of vehicle 3, and is capable of changing the orientation of grips 10 on the steering wheel in front of the driver's seat of vehicle 3.

More specifically, as illustrated in FIG. 1 and FIG. 2, vehicle steering apparatus 1 includes spoke 2, a pair of grips 10, a pair of first actuators 21, and controller 30.

Spoke 2 is a rod-shaped component that is coupled to steering column 4 and extends left and right from steering column 4 when the steering position during driving is in the neutral position. Note that the neutral steering position refers to a state in which spoke 2 is orientated parallel to the left and right directions (horizontal direction) so that vehicle 3 can travel straight forward.

The pair of grips 10 are arranged on both ends of spoke 2 in the left and right directions. In other words, the pair of grips 10 are arranged on the left and right of spoke 2. Each grip 10 is arc-shaped.

Although the pair of grips 10 are exemplified as being arc-shaped in the present embodiment, the pair of grips 10 are not limited to this example, and may be in the shape of a straight line.

The pair of grips 10 are rotatable relative to spoke 2. The pair of grips 10 are automatically rotatable relative to spoke 2 via the pair of first actuators 21 under control by controller 30. The pair of grips 10 are separated and independently rotatable about an axis extending in the left and right directions of spoke 2. Accordingly, the pair of grips 10 are capable of independently rotating about an axis extending in the left and right directions of spoke 2.

Each grip 10 includes a first portion and a second portion.

The first portion is a portion extending in toward the ceiling of vehicle 3 relative to spoke 2 when the steering position during driving is in the neutral position.

The second portion is a portion extending toward the floor of vehicle 3 relative to spoke 2 when the steering position during driving is in the neutral position.

In each grip 10, when the steering position during driving is in the neutral position, the length of the first portion and the length of the second portion are different. Here, the longer of the first portion and the second portion will be referred to as long portion 11a, and the shorter will be referred to as short portion 12a. Although (a) in FIG. 1 illustrates an example in which long portion 11a extends toward the floor of vehicle 3 and short portion 12a extends toward the ceiling of vehicle 3 as the neutral position, the neutral position is not limited to this example. For example, long portion 11a may extend toward the ceiling of vehicle 3 and short portion 12a may extend toward the floor of vehicle 3 as the neutral position. Accordingly, when the first portion is long portion 11a, the second portion is short portion 12a, and when the first portion is short portion 12a, the second portion is long portion 11a.

As illustrated in (a) in FIG. 1, each grip 10 is capable of rotating such that, while driving, short portion 12a is positioned toward the ceiling of vehicle 3 relative to spoke 2 and long portion 11a is positioned toward the floor of vehicle 3 relative to spoke 2. Stated differently, since each grip 10 is rotatable relative to spoke 2, it is possible for each grip 10 to assume an orientation in which long portion 11a extends toward the floor of vehicle 3 relative to spoke 2 and short portion 12a extends toward the ceiling of vehicle 3 relative to spoke 2. Note that each grip 10 may be capable of rotating such that, while driving, short portion 12a is positioned toward the floor of vehicle 3 relative to spoke 2 and long portion 11a is positioned toward the ceiling of vehicle 3 relative to spoke 2.

Since each grip 10 is rotatable relative to spoke 2, each grip 10 can rotate such that, while parked, short portion 12a is positioned toward the rear of vehicle 3 relative to spoke 2 and long portion 11a is positioned toward the front of vehicle 3 relative to spoke 2, as illustrated in (b) in FIG. 1. Stated differently, since each grip 10 is rotatable relative to spoke 2, it is possible for each grip 10 to assume an orientation in which short portion 12a extends toward the rear of vehicle 3 relative to spoke 2 and long portion 11a extends toward the front of vehicle 3 relative to spoke 2.

As illustrated in (c) in FIG. 1, while the driver enters or exits vehicle 3, grip 10 adjacent to door 9 of vehicle 3 adjacent to vehicle steering apparatus 1 can be oriented such that long portion 11a is positioned toward the ceiling of vehicle 3 relative to spoke 2 and short portion 12a is positioned toward the floor of vehicle 3 relative to spoke 2 so as to allow the driver to enter or exit vehicle 3 while holding grip 10. At this time, the other grip 10 can be oriented such that short portion 12a extends toward the rear of vehicle 3 and long portion 11a extends toward the front of vehicle 3.

Although long portion 11a is exemplified as extending toward the ceiling of vehicle 3 and short portion 12a extending toward the floor of vehicle 3 while the driver enters or exits vehicle 3 in the present embodiment, the present disclosure is not limited to this example. In other words, in an effort to prevent grip 10 from obstructing the driver while entering or exiting vehicle 3, grip 10 can be rotated such that long portion 11a extends in a direction other than toward the ceiling of vehicle 3, for example, toward the front vehicle 3 or toward the front windshield, i.e., between a direction toward the front of vehicle and a direction toward the ceiling of vehicle 3. However, since entering or exiting vehicle 3 while holding grip 10 could become difficult in some cases with these configurations, it is preferable that long portion 11a extends toward the ceiling of vehicle 3 while the driver enters of exits vehicle 3.

In the pair of grips 10, when the steering position during driving is in the neutral position, a gap is formed between long portion 11a of one grip 10 and long portion 11a of the other grip 10. Accordingly, in configurations in which each grip 10 individually rotates, the pair of grips 10 can be configured to avoid interference with steering column 4 and column cover 6 (see FIG. 3) that covers the bottom of steering column 4.

As illustrated in FIG. 1 and FIG. 2, the pair of first actuators 21 are provided corresponding to the pair of grips 10. Accordingly, the pair of first actuators 21 correspond to and rotate the pair of grips 10 one-to-one.

Controller 30 is electrically connected to the pair of first actuators 21, and controls each of the pair of first actuators 21 individually.

More specifically, as illustrated in (a) in FIG. 1 and FIG. 2, controller 30 controls the pair of first actuators 21 such that, when vehicle 3 is being driven manually, either long portions 11a or short portions 12a of the pair of grips 10 extend toward the ceiling of vehicle 3. With this, when vehicle 3 is being driven manually, long portions 11a of the pair of grips 10 extend toward the ceiling of vehicle 3 and short portions 12a of the pair of grips 10 to extend toward the floor of vehicle 3. Alternatively, as illustrated in (a) in FIG. 1, short portions 12a of the pair of grips 10 extend toward the ceiling of vehicle 3 and long portions 11a of the pair of grips 10 extend toward the floor of vehicle 3.

As illustrated in (b) in FIG. 1 and FIG. 2, controller 30 controls the pair of first actuators 21 such that, when vehicle 3 is parked or autonomously driving, short portions 12a of the pair of grips 10 extend toward the rear of vehicle 3 and long portions 11a of the pair of grips 10 extend toward the front of vehicle 3. With this, when vehicle 3 is parked or autonomously driving, short portions 12a of the pair of grips 10 extend toward the rear of vehicle 3 and long portions 11a of the pair of grips 10 extend toward the front of vehicle 3.

As illustrated in (c) in FIG. 1 and FIG. 2, controller 30 controls first actuator 21 adjacent to door 9 of vehicle 3 adjacent to vehicle steering apparatus 1 such that while the driver is entering or exiting vehicle 3, long portion 11a of grip 10 adjacent to said door 9 of vehicle 3 extends toward the ceiling of vehicle 3, and short portion 12a of said grip 10 extends toward the floor of vehicle 3. With this, while the driver is entering or exiting vehicle 3, long portion 11a of grip 10 adjacent to door 9 extends toward the ceiling of vehicle 3 and short portion 12a of said grip 10 extends toward the floor of vehicle 3. Note in cases in which the driver has exited vehicle 3, controller 30 may maintain grip 10 adjacent door 9 in an orientation in which long portion 11a of said grip 10 is extending toward the ceiling of vehicle 3 and short portion 12a of said grip 10 is extending toward the floor of vehicle 3. In such cases, the driver can enter vehicle 3 while holding said grip 10.

As illustrated in (d) in FIG. 1, FIG. 2, and FIG. 3, vehicle steering apparatus 1 may further include table 50 and second actuator 22.

Table 50 is disposed below vehicle steering apparatus 1 and is capable of moving in the front and rear directions of vehicle 3. Table 50 is storable in a storage space in column cover 6 that covers the bottom of steering column 4. Table 50 deploys from the storage space in column cover 6 so as to move closer to the driver's seat.

Table 50 further includes input interface 51. Input interface 51 is a touch pad, a touch panel, or a projection keyboard. When input interface 51 is a touch pad or a touch panel, it is provided in table 50. The projection keyboard may be realized by a projection device arranged on, for example, spoke 2, projecting an image of a keyboard onto the surface of table 50 and a detector arranged on, for example, spoke 2, detecting the positions of the driver's fingers.

Second actuator 22 actuates table 50 so as to move table 50 in the front and rear directions of vehicle 3. More specifically, when second actuator 22 actuates table 50 so as to move table 50 from steering column 4 towards the rear of vehicle 3, it protrudes table 50 from column cover 6 and positions table 50 directly in front of the driver's seat. Second actuator 22 actuates table 50 so as to move table 50 toward the front of vehicle 3 and store table 50 in the storage space in column cover 6.

Controller 30 controls second actuator 22 to move table 50 from steering column 4 toward the front of vehicle 3 when parked. While driving or when the driver is entering or exiting vehicle 3, controller 30 controls second actuator 22 to move table 50 toward the front of vehicle 3 so as to store table 50 in the storage space in column cover 6.

### Operation Example 1

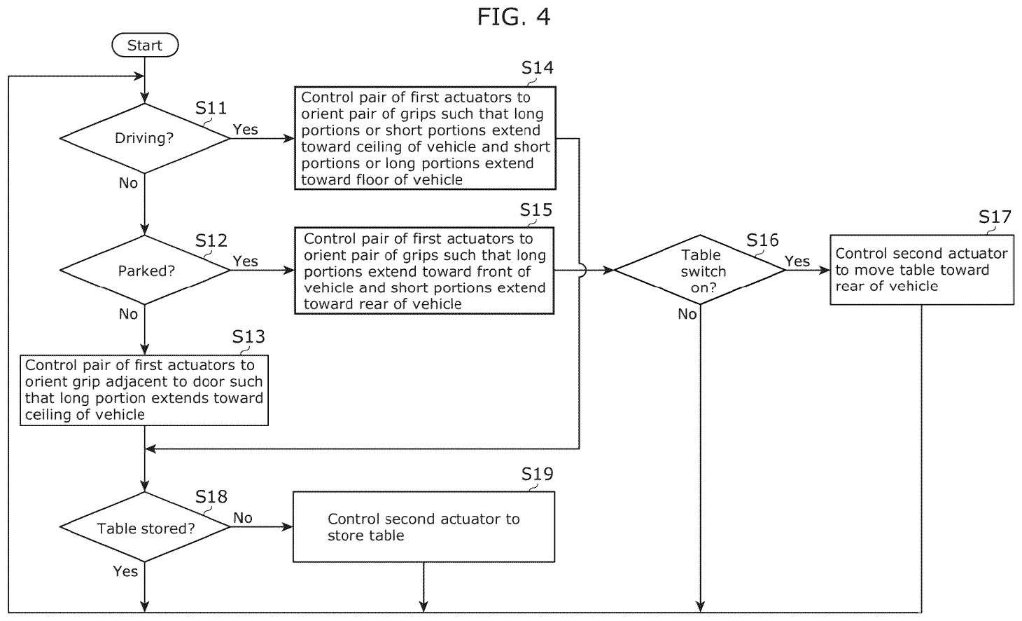

Next, an operation example of vehicle steering apparatus 1 will be described with reference to FIG. 4 and the like.

FIG. 4 is a flowchart illustrating vehicle steering apparatus 1 including a pair of automatically rotatable grips 10.

First, controller 30 determines whether vehicle 3 is driving or not (S11). Whether vehicle 3 is driving or not may be determined by determining whether controller 30 has obtained from, for example, an electronic control unit (ECU), information indicating that the ignition switch is on and the gear lever is in drive (D).

As illustrated in (a) in FIG. 1, FIG. 2, and FIG. 4, when controller 30 determines that vehicle 3 is driving (Yes in S11), controller 30 controls the pair of first actuators 21 so as to orient the pair of grips 10 such that long portions 11a or short portions 12a are extending toward the ceiling of vehicle 3 and short portions 12a or long portions 11a are extending toward the floor of vehicle 3 (S14). With this, the pair of grips 10 rotate, resulting in either long portions 11a or short portions 12a extending toward the ceiling of vehicle 3 and short portions 12a or long portions 11a extending toward the floor of vehicle 3. Controller 30 proceeds to step S18.

However, when controller 30 determines that vehicle 3 is not driving (No in S11), controller 30 determines whether vehicle 3 is parked or not (S12). Whether vehicle 3 is parked or not may be determined by determining whether controller 30 has obtained from, for example, an ECU, information indicating that the ignition switch is on and the gear lever is in park (P), or indicating that the ignition switch is off and door 9 is closed.

When controller 30 determines that vehicle 3 is parked (Yes in S12), as illustrated in (b) in FIG. 1, FIG. 2, and FIG. 4, controller 30 controls the pair of first actuators 21 so as to orient the pair of grips 10 such that long portions 11a are extending toward the front of vehicle 3 and short portions 12a are extending toward the rear of vehicle 3 (S15). With this, the pair of grips 10 rotate, resulting in long portions 11a extending toward the front of vehicle 3 and short portions 12a extending toward the rear of vehicle 3.

Note that in step S12, controller 30 determines whether vehicle 3 is parked or not, but this example is non-limiting. For example, controller 30 may be configured to determine whether vehicle 3 is autonomously driving or not.

Next, controller 30 determines whether the switch for table 50 is on or not (S16).

When controller 30 determines that the switch for table 50 is off (No in S16), controller 30 returns to step S11.

When controller 30 determines that the switch for table 50 is on (Yes in S16), as illustrated in (d) in FIG. 1, FIG. 2, and FIG. 4, controller 30 controls second actuator 22 to move table 50 toward the rear of vehicle 3 (S17). With this, table 50 moves from the storage space in column cover 6 toward the rear of vehicle 3 so as to be deployed to a position directly in front of the driver's seat. Controller 30 then returns to step S11.

In step S12 described above, when controller 30 determines that vehicle 3 is not parked (No in S12), since this implies the driver is not in the process of entering or exiting vehicle 3, as illustrated in (c) in FIG. 1, FIG. 2, and FIG. 4, controller 30 controls the pair of first actuators 21 so as to orient grip 10 adjacent to door 9 of vehicle 2 adjacent to vehicle steering apparatus 1 such that long portion 11a is extending toward the ceiling of vehicle 3 (S13). With this, grip 10 adjacent to door 9 rotates, resulting in long portion 11a extending toward the ceiling of vehicle 3 and short portion 12a extending toward the floor of vehicle 3. Whether the driver is entering or exiting vehicle 3 or not may be determined by determining whether controller 30 has obtained from, for example, an ECU, information indicating that the ignition switch is off and door 9 is open.

Next, controller 30 determines whether table 50 is stored in the storage space in column cover 6 or not (S18).

When controller 30 determines that table 50 is stored in the storage space in column cover 6 (Yes in S18), controller 30 returns to step S11.

However, when controller 30 determines that table 50 is not stored in the storage space in column cover 6 (No in S18), controller 30 controls second actuator 22 to store table 50 in the storage space (S19). With this, table 50 moves toward the front of vehicle 3, and is stored in the storage space in column cover 6. Controller 30 then returns to step S11.

### Configuration and Function in Manual Mode

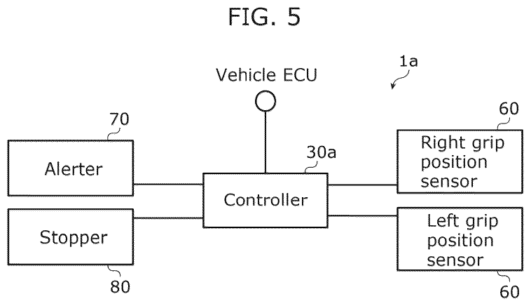

Hereinbefore, an example was given in which the pair of grips 10 are automatically rotatable. Next, an example in which the pair of grips 10 are manually rotatable relative to spoke 2 will be given with reference to FIG. 5.

FIG. 5 is a block diagram illustrating vehicle steering apparatus 1a including a pair of manually rotatable grips 10.

In this example, vehicle steering apparatus 1a may further include a pair of position sensors 60, table 50, stopper 80, and alerter 70. Moreover, vehicle steering apparatus 1a need not include the pair of first actuators 21 and second actuator 22.

The pair of position sensors 60 are provided in one-to-one correspondence with the pair of grips 10. The pair of position sensors 60 respectively detect the rotational positions of the pair of grips 10. Each position sensor 60 outputs the rotational position of the corresponding grip 10 to controller 30a. The rotational position is indicated by, for example, the attitude (position) of grip 10 relative to spoke 2, and/or the angle or rotation of grip 10.

Controller 30a is electrically connected to the pair of position sensors 60, and obtains the rotational positions of the pair of grips 10 from the pair of position sensors 60.

More specifically, when controller 30a determines that long portions 11a or short portions 12a of the pair of grips 10 are oriented extending toward the ceiling of vehicle 3 based on the rotational positions of the pair of grips 10 detected by the pair of position sensors 60, controller 30a outputs a ready-to-drive signal. In other words, since long portions 11a of the pair of grips 10 are extending toward the ceiling or floor of vehicle 3 and short portions 12a of the pair of grips 10 are extending toward the floor or ceiling of vehicle 3, the pair of grips 10 are in an orientation in which the driver can hold the pair of grips 10 and drive vehicle 3. In this case, controller 30a outputs a ready-to-drive signal.

When controller 30a determines that short portions 12a of the pair of grips 10 are oriented extending toward the rear of vehicle 3 and long portions 11a of the pair of grips 10 are oriented extending toward the front of vehicle 3 based on the rotational positions of the pair of grips 10 detected by the pair of position sensors 60, controller 30a outputs a parked signal. In other words, when the steering position during driving is the neutral position, since the pair of grips 10 are oriented laid flat parallel to the horizontal direction, the driver does not drive vehicle 3. In this case, controller 30a outputs a parked signal.

When controller 30a determines that long portion 11a of grip 10 adjacent to door 9 of vehicle 3 adjacent to vehicle steering apparatus 1a is extending toward the ceiling of vehicle 3 and short portion 12a of said grip 10 is extending toward the floor of vehicle 3 based on the rotational positions of the pair of grips 10 detected by the pair of position sensors 60, controller 30a outputs a door unlock authorization signal. In other words, when the driver wishes to unlock door 9 of vehicle 3 adjacent to vehicle steering apparatus 1a, the driver manually adjusts the orientation of grip 10 adjacent to door 9 such that long portion 11a of said grip 10 extends toward the ceiling of vehicle 3 and short portion 12a of said grip 10 extends toward the floor of vehicle 3. This causes controller 30a to output a door unlock authorization signal, whereby the driver can exit vehicle 3. Moreover, in cases in which the driver is entering vehicle 3, the driver may sit in the driver's seat while holding long portion 11a of grip 10 adjacent to door 9. This makes it easier for the driver to enter and exit vehicle 3.

Table 50 may be manually deployable. Table 50 is disposed below the steering wheel and is capable of moving in the front and rear directions of vehicle 3. Table 50 is storable in a storage space in column cover 6 that covers the bottom of steering column 4. Table 50 is moved closer to the driver's seat by being deployed from inside column cover 6. Table 50 further includes input interface 51.

Stopper 80 is electrically connected to controller 30a and restricts movement of table 50. Stopper 80 is, for example, a solenoid stopper including an electromagnetic actuator or the like.

Stopper 80 can, under control by controller 30a, restrict movement of table 50 and unrestrict movement of table 50. When stopper 80 is unlocked, it outputs a signal indicating that it is unlocked to controller 30a. When stopper 80 is locked, it outputs a signal indicating that it is locked to controller 30a.

When controller 30a has output the parked signal, controller 30a unlocks stopper 80 that restricts movement of table 50 toward the rear of vehicle 3. In other words, the driver may want to deploy table 50 stored in the storage space in column cover 6 while vehicle 3 is parked, so controller 30a actuates and unlocks stopper 80.

Upon outputting a ready-to-drive signal or a door unlock authorization signal, if stopper 80 is unlocked, controller 30a causes alerter 70 to output an alert prompting storage of table 50.

Alerter 70 is, for example, an audio device or a display device that is equipped in vehicle 3. The alert is, for example, a sound output by the audio device that prompts storage of table 50 or display content displayed by the display device that prompts storage of table 50.

### Operation Example 2

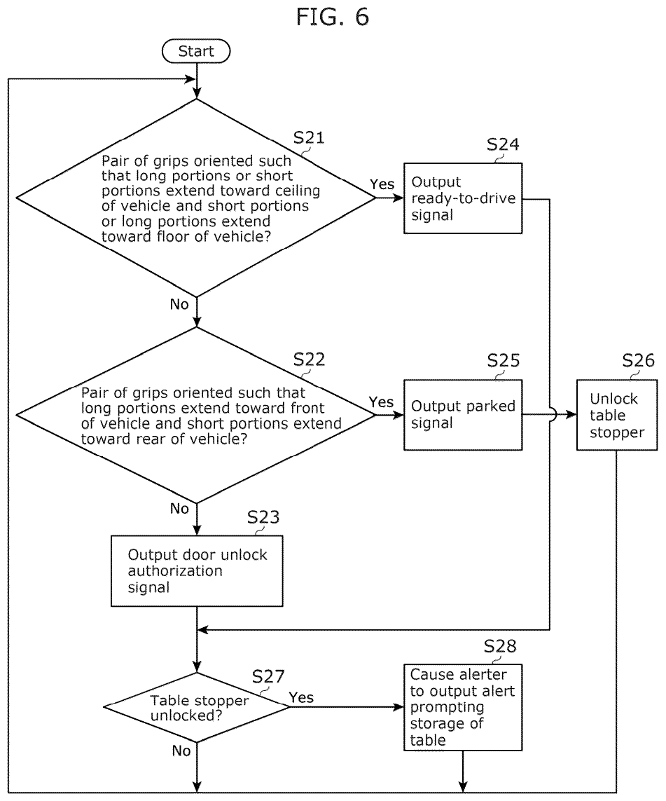

Next, an operation example of vehicle steering apparatus 1a will be described with reference to FIG. 6 and the like.

FIG. 6 is a flowchart illustrating vehicle steering apparatus 1a including a pair of manually rotatable grips 10.

As illustrated in FIG. 5 and FIG. 6, controller 30a determines whether the pair of grips 10 are oriented such that long portions 11a or short portions 12a are extending toward the ceiling of vehicle 3 and short portions 12a or long portions 11a are extending toward the floor of vehicle 3 based on the rotational positions of the pair of grips 10 detected by the pair of position sensors 60 (S21).

When controller 30a determines that the pair of grips 10 are oriented such that long portions 11a or short portions 12a are extending toward the ceiling of vehicle 3 and short portions 12a or long portions 11a are extending toward the floor of vehicle 3 (Yes in S21), controller 30a outputs a ready-to-drive signal to the ECU (S24). With this, vehicle 3 is drivable. Controller 30a proceeds to step S27.

However, when controller 30a determines that the pair of grips 10 are not oriented such that long portions 11a or short portions 12a are not extending toward the ceiling of vehicle 3 (No in S21), controller 30a determines whether the pair of grips 10 are oriented such that long portions 11a are extending toward the front of vehicle 3 and short portions 12a are extending toward the rear of vehicle 3 (S22).

When controller 30a determines that the pair of grips 10 are oriented such that long portions 11a are extending toward the front of vehicle 3 and short portions 12a are extending toward the rear of vehicle 3 (Yes in S22), controller 30a outputs a parked signal (S25).

Next, when controller 30a has output the parked signal, controller 30a controls stopper 80 that restricts movement of table 50 toward the rear of vehicle 3 so as to unlock stopper 80 (S26). Controller 30a then returns to step S21.

In step S22 described above, when controller 30a determines that the pair of grips 10 are not oriented such that long portions 11a are extending toward the front of vehicle 3 and short portions 12a are extending toward the rear of vehicle 3 (No in S22), as this state is neither (a) nor (b) in FIG. 1, controller 30a determines it to be state (c) in FIG. 1, and outputs a door unlock authorization signal to the ECU (S23).

Next, controller 30a determines whether stopper 80 is unlocked or not (S27).

When controller 30a determines that stopper 80 is not unlocked (No in S27), it returns to step S21. Therefore, since stopper 80 not being unlocked indicates table 50 is stored in the storage space within column cover 6, the pair of grips 10 are capable of being oriented such that long portions 11a or short portions 12a extend toward the ceiling of vehicle 3 and short portions 12a or long portions 11a extend toward the floor of vehicle 3.

When controller 30a determines that stopper 80 is unlocked (Yes in S27), controller 30a causes alerter 70 to output an alert prompting storage of table 50 (S28). Controller 30a then returns to step S21.

Although the present embodiment presents an example in which vehicle steering apparatus 1a includes table 50, vehicle steering apparatus 1a is not required to include table 50.

### Embodiment Variations

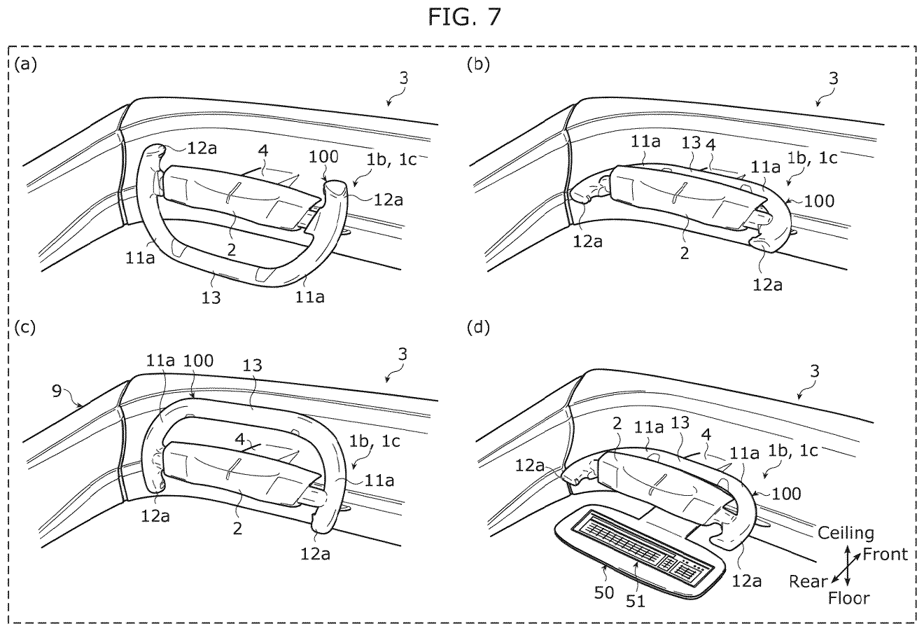

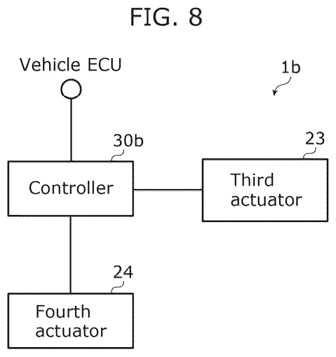

Next, vehicle steering apparatus 1b according to the present variation will be described with reference to FIG. 7 and FIG. 8.

FIG. 7 is a perspective view illustrating vehicle steering apparatus 1b including an automatically rotatable steering wheel 100. In FIG. 7, (a) illustrates vehicle steering apparatus 1b when the steering position during driving is in the neutral position. In FIG. 7, (b) illustrates vehicle steering apparatus 1b with steering wheel 100 laid flat horizontally. In FIG. 7, (c) illustrates vehicle steering apparatus 1b with steering wheel 100 oriented vertically such that connecting portion 13 is positioned above spoke 2. In FIG. 7, (d) illustrates vehicle steering apparatus 1b with steering wheel 100 laid flat horizontally and table 50 deployed. FIG. 8 is a block diagram illustrating vehicle steering apparatus 1b including the automatically rotatable steering wheel 100.

The pair of grips 10 according to the present variation differ from the pair of grips 10 according to the embodiment in that corresponding ends of the pair of grips 10 are integrally connected. The configuration of vehicle steering apparatus 1b according to the present variation is similar to that described in the embodiment, so the same reference signs are used for vehicle steering apparatus 1b according to the present variation, and descriptions are omitted as appropriate.

### Configuration and Function in Automatic Mode

In the present variation, one end (long portion 11a) of one grip in the pair of grips and one end (long portion 11a) of the other grip in the pair of grips are connected together via connecting portion 13, forming semicircular grips. In the present variation, the pair of grips connected by connecting portion 13 (the semicircular grips) is referred to as steering wheel 100.

As illustrated in FIG. 7 and FIG. 8, vehicle steering apparatus 1b according to the present variation includes spoke 2, steering wheel 100, third actuator 23, and controller 30b.

The left end portion of steering wheel 100 is connected to the left end portion of spoke 2, and the right end portion of steering wheel 100 is connected to the right end portion of spoke 2.

Steering wheel 100 is rotatable relative to spoke 2. Steering wheel 100 is automatically rotatable relative to spoke 2 via third actuator 23 under control by controller 30b. Steering wheel 100 rotates as a single unit relative to spoke 2 since the pair of grips 10 are integrated via connecting portion 13.

Steering wheel 100 includes connecting portion 13, which corresponds to the above-described long portion 11a, and short portions 12a.

As illustrated in (a) in FIG. 7, steering wheel 100 is capable of rotating such that, while driving, short portions 12a are positioned toward the ceiling of vehicle 3 relative to spoke 2 and connecting portion 13 is positioned toward the floor of vehicle 3 relative to spoke 2. Stated differently, since steering wheel 100 is rotatable relative to spoke 2, it is possible for steering wheel 100 to assume an orientation in which connecting portion 13 is positioned toward the floor of vehicle 3 relative to spoke 2 and short portions 12a extend toward the ceiling of vehicle 3 relative to spoke 2. Note that steering wheel 100 may be capable of rotating such that, while driving, short portions 12a are positioned toward the floor of vehicle 3 relative to spoke 2 and connecting portion 13 is positioned toward the ceiling of vehicle 3 relative to spoke 2.

Since steering wheel 100 is rotatable relative to spoke 2, steering wheel 100 can rotate such that, while parked, short portions 12a are positioned toward the rear of vehicle 3 relative to spoke 2 and long portions 11a are positioned toward the front of vehicle 3 relative to spoke 2, as illustrated in (b) in FIG. 7. Stated differently, since steering wheel 100 is rotatable relative to spoke 2, it is possible for steering wheel 100 to assume an orientation in which short portions 12a are positioned toward the rear of vehicle 3 relative to spoke 2 and connecting portion 13 is positioned toward the front of vehicle 3 relative to spoke 2.

As illustrated in (c) in FIG. 7, while the driver enters or exits vehicle 3, steering wheel 100 can be oriented such that connecting portion 13 is positioned toward the ceiling of vehicle 3 relative to spoke 2 and short portions 12a extend toward the floor of vehicle 3 relative to spoke 2 so as to allow the driver to enter or exit vehicle 3 while holding steering wheel 100.

Although connecting portion 13 is exemplified as being positioned toward the ceiling of vehicle 3 relative to spoke 2 and short portions 12a extending toward the floor of vehicle 3 while the driver enters or exits vehicle 3 in the present variation, the present disclosure is not limited to this example. In other words, in an effort to prevent steering wheel 100 from obstructing the driver while entering or exiting vehicle 3, steering wheel 100 can be rotated such that connecting portion 13 is positioned in a direction other than toward the ceiling of vehicle 3 relative to spoke 2, for example, toward the front of vehicle 3 or toward the front windshield, i.e., between a direction toward the front of vehicle and a direction toward the ceiling of vehicle 3. However, since entering or exiting vehicle 3 while holding steering wheel 100 could become difficult in some cases with these configurations, it is preferable that connecting portion 13 is positioned toward the ceiling of vehicle 3 relative to spoke 2 while the driver enters of exits vehicle 3.

Third actuator 23 actuates to rotate steering wheel 100.

Controller 30b is electrically connected to third actuator 23, and controls third actuator 23.

More specifically, as illustrated in (a) and (c) in FIG. 7 and FIG. 8, controller 30b controls third actuator 23 such that, while vehicle 3 is driving, either connecting portion 13 or short portions 12a of steering wheel 100 are positioned toward the ceiling of vehicle 3 relative to spoke 2. With this, while vehicle 3 is driving, connecting portion 13 of steering wheel 100 is positioned toward the ceiling of vehicle 3 relative to spoke 2 and short portions 12a of steering wheel 100 extend toward the floor of vehicle 3. Alternatively, as illustrated in (a) in FIG. 7, short portions 12a of steering wheel 100 extend toward the ceiling of vehicle 3 and connecting portion 13 of steering wheel 100 is positioned toward the floor of vehicle 3 relative to spoke 2.

As illustrated in (b) in FIG. 7 and FIG. 8, controller 30b controls third actuator 23 such that, when vehicle 3 is parked or autonomously driving, short portions 12a of steering wheel 100 extend toward the rear of vehicle 3 and connecting portion 13 of steering wheel 100 is positioned toward the front of vehicle 3 relative to spoke 2. With this, when vehicle 3 is parked, short portions 12a of steering wheel 100 extend toward the rear of vehicle 3 and connecting portion 13 of steering wheel 100 is positioned toward the front of vehicle 3 relative to spoke 2.

As illustrated in (c) in FIG. 7 and FIG. 8, controller 30b controls third actuator 23 such that while the driver is entering or exiting vehicle 3, connecting portion 13 of steering wheel 100 is positioned toward the ceiling of vehicle 3 relative to spoke 2, and short portions 12a of steering wheel 100 extend toward the floor of vehicle 3. With this, while the driver is entering or exiting vehicle 3, connecting portion 13 of steering wheel 100 is positioned toward the ceiling of vehicle 3 relative to spoke 2 and short portions 12a of steering wheel 100 extend toward the floor of vehicle 3.

Note that when connecting portion 13 of steering wheel 100 is positioned toward the ceiling of vehicle 3 during driving, controller 30b controls third actuator 23 to differentiate the position of connecting portion 13 during driving from the position of connecting portion 13 while the driver is entering or exiting vehicle 3 so as to be distinguishable to the driver. In other words, controller 30b controls third actuator 23 so as to position connecting portion 13 toward the ceiling relative to spoke 2, tilted slightly toward the front windshield during driving, and controls third actuator 23 so as to position connecting portion 13 toward the ceiling relative to spoke 2, tilted slightly toward the seat while the driver enters or exits vehicle 3.

Moreover, just like in the above embodiment, vehicle steering apparatus 1b may further include table 50 and fourth actuator 24.

As illustrated in (d) in FIG. 7, table 50 is disposed below vehicle steering apparatus 1b and is capable of moving in the front and rear directions of vehicle 3. Table 50 is storable in a storage space in column cover 6 (see FIG. 3) that covers the bottom of steering column 4. Table 50 is moved closer to the driver's seat by being deployed from the storage space in column cover 6.

Table 50 further includes input interface 51. Input interface 51 is a touch pad, a touch panel, or a projection keyboard.

Fourth actuator 24 actuates table 50 so as to move table 50 in the front and rear directions of vehicle 3. More specifically, when fourth actuator 24 actuates table 50 so as to move table 50 from steering column 4 towards the rear of vehicle 3, it protrudes table 50 from column cover 6 and positions table 50 directly in front of the driver's seat. Fourth actuator 24 actuates table 50 so as to move table 50 toward the front of vehicle 3 and store table 50 in the storage space in column cover 6.

Controller 30b controls fourth actuator 24 to move table 50 from steering column 4 toward the front of vehicle 3 when parked.

While driving or when the driver is entering or exiting vehicle 3, controller 30b controls fourth actuator 24 to move table 50 toward the front of vehicle 3 so as to store table 50 in the storage space in column cover 6.

### Operation Example 1

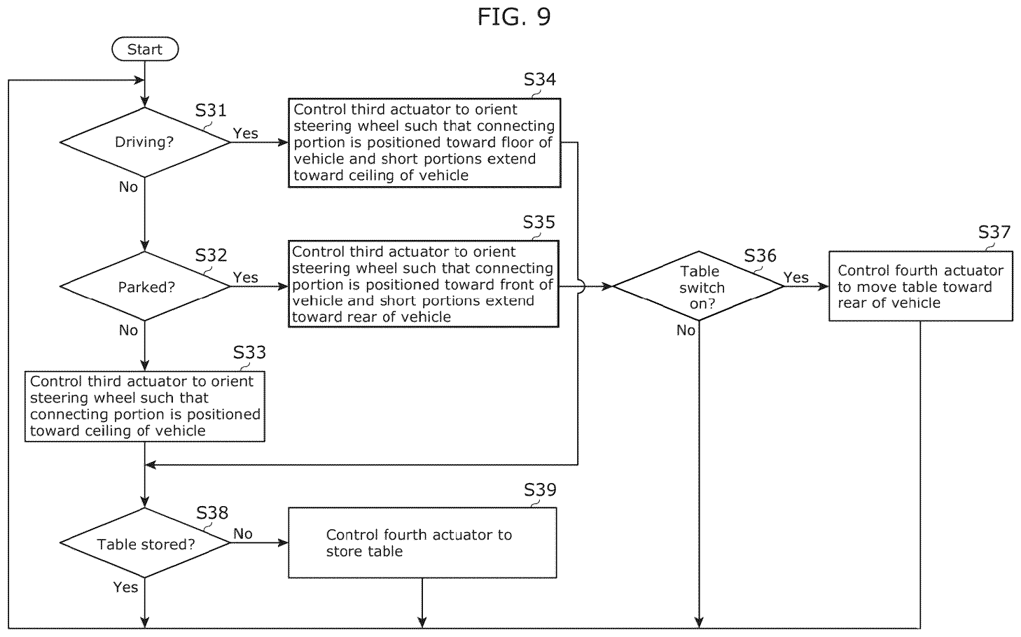

Next, an operation example of vehicle steering apparatus 1b will be described with reference to FIG. 9.

FIG. 9 is a flowchart illustrating vehicle steering apparatus 1b including the automatically rotatable steering wheel 100. The following description pertains to a case where, while driving, connecting portion 13 of steering wheel 100 is positioned toward the floor of vehicle 3 relative to spoke 2.

First, controller 30b determines whether vehicle 3 is driving or not (S31).

When controller 30b determines that vehicle 3 is driving (Yes in S31), controller 30b controls third actuator 23 such that connecting portion 13 of steering wheel 100 is positioned toward the floor of vehicle 3 relative to spoke 2, and short portions 12a extend toward the ceiling of vehicle 3 (S34). With this, steering wheel 100 rotates, resulting in connecting portion 13 being positioned toward the floor of vehicle 3 relative to spoke 2 and short portions 12a extending toward the ceiling of vehicle 3. Controller 30b proceeds to step S38.

However, when controller 30b determines that vehicle 3 is not driving (No in S31), controller 30b determines whether vehicle 3 is parked or not (S32).

When controller 30b determines that vehicle 3 is parked (Yes in S32), as illustrated in (b) in FIG. 7, FIG. 8, and FIG. 9, controller 30b controls third actuator 23 such that connecting portion 13 of steering wheel 100 is positioned toward the front of vehicle 3 relative to spoke 2, and short portions 12a extend toward the rear of vehicle 3 (S35). With this, steering wheel 100 rotates, resulting in connecting portion 13 being positioned toward the front of vehicle 3 relative to spoke 2 and short portions 12a extending toward the rear of vehicle 3.

Note that in step S32, controller 30b determines whether vehicle 3 is parked or not, but this example is non-limiting. For example, controller 30b may be configured to determine whether vehicle 3 is autonomously driving or not.

Next, controller 30b determines whether the switch for table 50 is on or not (S36).

When controller 30b determines that the switch for table 50 is off (No in S36), controller 30b returns to step S31.

When controller 30b determines that the switch for table 50 is on (Yes in S36), as illustrated in (d) in FIG. 7, FIG. 8, and FIG. 9, controller 30b controls fourth actuator 24 to move table 50 toward the rear of vehicle 3 (S37). With this, table 50 moves from column cover 6 toward the rear of vehicle 3 so as to be deployed to a position directly in front of the driver's seat. Controller 30b then returns to step S31.

In step S32 described above, when controller 30b determines that vehicle 3 is not parked (No in S32), since this implies the driver is in the process of entering or exiting vehicle 3, as illustrated in (c) in FIG. 7, FIG. 8, and FIG. 9, controller 30b controls third actuator 23 such that connecting portion 13 of steering wheel 100 is positioned toward the ceiling of vehicle 3 relative to spoke 2 (S33). With this, steering wheel 100 rotates, resulting in connecting portion 13 being positioned toward the ceiling of vehicle 3 relative to spoke 2 and short portions 12a extending toward the floor of vehicle 3.

Next, controller 30b determines whether table 50 is stored in the storage space in column cover 6 or not (S38).

When controller 30b determines that table 50 is stored in the storage space in column cover 6 (Yes in S38), controller 30b returns to step S31.

However, when controller 30b determines that table 50 is not stored in the storage space in column cover 6 (No in S38), controller 30b controls fourth actuator 24 to store table 50 (S39). With this, table 50 moves toward the front of vehicle 3, and is stored in the storage space in column cover 6. Controller 30b then returns to step S31.

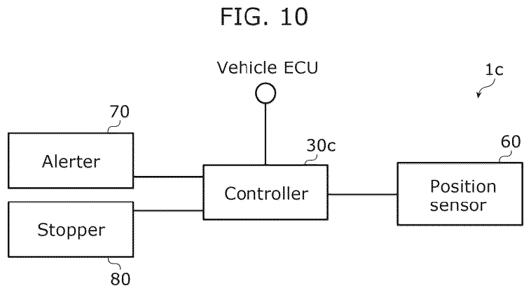

Configuration and Function in Manual Mode Hereinbefore, an example was given in which steering wheel 100 is automatically rotatable. Next, an example in which steering wheel 100 is manually rotatable relative to spoke 2 will be given with reference to FIG. 10.

FIG. 10 is a block diagram illustrating vehicle steering apparatus 1c including the manually rotatable steering wheel 100.

In this example, vehicle steering apparatus 1c may further include position sensor 60, table 50, stopper 80, and alerter 70. Moreover, vehicle steering apparatus 1c need not include third actuator 23 and fourth actuator 24.

Position sensor 60 detects the rotational positions of steering wheel 100. Position sensor 60 outputs the rotational positions of steering wheel 100 to controller 30c.

Controller 30c is electrically connected to position sensor 60 and obtains rotational positions of steering wheel 100.

More specifically, when controller 30c determines that either connecting portion 13 or short portions 12a of steering wheel 100 is positioned toward the ceiling of vehicle 3 relative to spoke 2 based on the rotational positions of steering wheel 100 detected by position sensor 60, controller 30c outputs a ready-to-drive signal. In other words, since connecting portion 13 of steering wheel 100 is positioned toward the ceiling or floor of vehicle 3 relative to spoke 2 and short portions 12a of steering wheel 100 are extending toward the floor or ceiling of vehicle 3, steering wheel 100 is in an orientation in which the driver can hold steering wheel 100 and drive vehicle 3. In this case, controller 30c outputs a ready-to-drive signal.

When controller 30c determines that short portions 12a of steering wheel 100 are oriented extending toward the rear of vehicle 3 and connecting portion 13 of steering wheel 100 is positioned toward the front of vehicle 3 relative to spoke 2 based on the rotational positions of steering wheel 100 detected by position sensor 60, controller 30c outputs a parked signal. In other words, when the steering position during driving is the neutral position, since steering wheel 100 is oriented laid flat parallel to the horizontal direction, the driver does not drive vehicle 3. In this case, controller 30c outputs a parked signal.

When controller 30c determines that connecting portion 13 of steering wheel 100 is positioned toward the ceiling of vehicle 3 relative to spoke 2 and short portions 12a of steering wheel 100 extend toward the floor of vehicle 3 based on the rotational positions of steering wheel 100 detected by position sensor 60, controller 30c outputs a door unlock authorization signal. In other words, when the driver wishes to unlock door 9 of vehicle 3 adjacent to vehicle steering apparatus 1c, the driver manually adjusts the orientation of steering wheel 100 such that connecting portion 13 is positioned toward the ceiling of vehicle 3 relative to spoke 2 and short portions 12a of steering wheel 100 extend toward the floor of vehicle 3. This causes controller 30c to output a door unlock authorization signal, whereby the driver can exit vehicle 3. Moreover, in cases in which the driver is entering vehicle 3, the driver may sit in the driver's seat while holding long portion 11a of steering wheel 100. This makes it easier for the driver to enter vehicle 3.

Note that when connecting portion 13 of steering wheel 100 is positioned toward the ceiling of vehicle 3 during driving, in order to differentiate between connecting portion 13 of steering wheel 100 being positioned toward the ceiling of vehicle 3 while the driver is entering or exiting vehicle 3, controller 30c determines whether vehicle 3 is driving or the driver is entering or exiting vehicle 3 according to the position of connecting portion 13 as detected by position sensor 60. In other words, a configuration is adopted that allows for positioning via, for example, a detent mechanism, whereby connecting portion 13 can be positioned toward the ceiling relative to spoke 2, tilted slightly toward the front windshield during driving, and connecting portion 13 can be positioned toward the ceiling relative to spoke 2, tilted slightly toward the seat while the driver enters or exits vehicle 3. This makes it possible for controller 30c to determine whether vehicle 3 is driving or the driver is entering or exiting vehicle 3 based on the output from position sensor 60.

Table 50 may be manually deployed. Table 50 is disposed below the steering wheel and is capable of moving in the front and rear directions of vehicle 3.

Stopper 80 is electrically connected to controller 30c and restricts movement of table 50. Stopper 80 can, under control by controller 30c, restrict movement of table 50 and unrestrict movement of table 50. When stopper 80 is unlocked, it outputs a signal indicating that it is unlocked to controller 30c. When stopper 80 is locked, it outputs a signal indicating that it is locked to controller 30c.

When controller 30c has output the parked signal, controller 30c unlocks stopper 80 that restricts movement of table 50 toward the rear of vehicle 3. In other words, the driver may want to deploy table 50 stored in the storage space in column cover 6 while vehicle 3 is parked, so controller 30c unlocks stopper 80.

Upon outputting a ready-to-drive signal or a door unlock authorization signal, if stopper 80 is unlocked, controller 30c causes alerter 70 to output an alert prompting storage of table 50.

### Operation Example 2

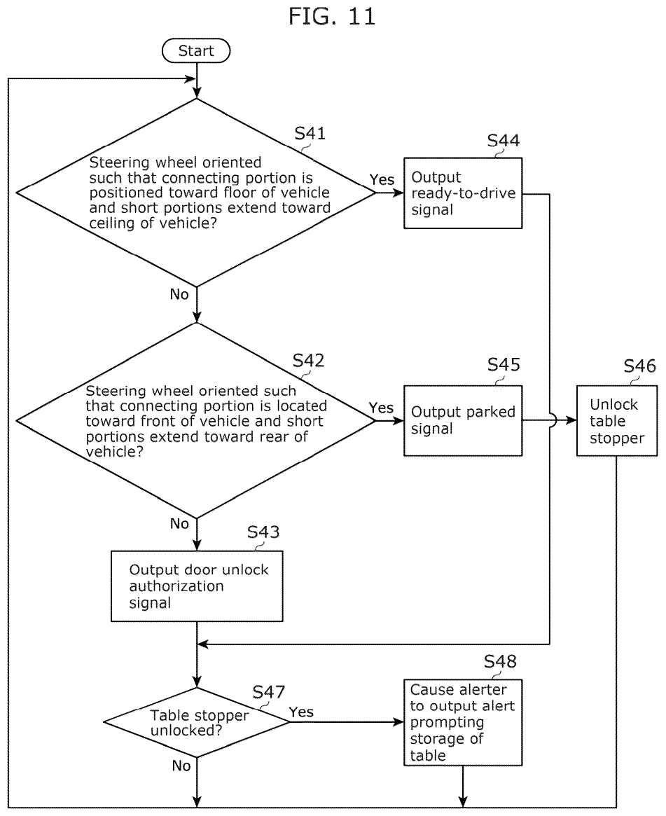

Next, an operation example of vehicle steering apparatus 1c will be described with reference to FIG. 11.

FIG. 11 is a flowchart illustrating vehicle steering apparatus 1c including the manually rotatable steering wheel 100. The following description pertains to a case where, while driving, connecting portion 13 of steering wheel 100 is positioned toward the floor of vehicle 3 relative to spoke 2.

First, controller 30c determines whether connecting portion 13 of steering wheel 100 is positioned toward the floor of vehicle 3 relative to spoke 2 and short portions 12a of steering wheel 100 extend toward the ceiling of vehicle 3 based on the rotational positions of steering wheel 100 detected by position sensor 60 (S41).

When controller 30c determines that steering wheel 100 is oriented such that connecting portion 13 is positioned toward the floor of vehicle 3 relative to spoke 2 and short portions 12a are extending toward the ceiling of vehicle 3 (Yes in S41), controller 30c outputs a ready-to-drive signal to the ECU (S44). With this, vehicle 3 is drivable. Controller 30c proceeds to step S47.

However, when controller 30c determines that steering wheel 100 is not oriented such that connecting portion 13 is positioned toward the floor of vehicle 3 relative to spoke 2 and short portions 12a are extending toward the ceiling of vehicle 3 (No in S41), controller 30c determines whether steering wheel 100 is oriented such that connecting portion 13 is positioned toward the front of vehicle 3 relative to spoke 2 and short portions 12a are extending toward the rear of vehicle 3 (S42).

When controller 30c determines that steering wheel 100 is oriented such that connecting portion 13 is positioned toward the front of vehicle 3 relative to spoke 2 and short portions 12a are extending toward the rear of vehicle 3 (Yes in S42), controller 30c outputs a parked signal (S45).

Next, when controller 30c has output the parked signal, controller 30c controls stopper 80 that restricts movement of table 50 toward the rear of vehicle 3 so as to unlock stopper 80 (S46). Controller 30c then returns to step S41.

In step S42 described above, when controller 30c determines that steering wheel 100 is not oriented such that connecting portion 13 is positioned toward the front of vehicle 3 relative to spoke 2 and short portions 12a are extending toward the rear of vehicle 3 (No in S42), as this state is neither (a) nor (b) in FIG. 7, controller 30c determines it to be state (c) in FIG. 7, and outputs a door unlock authorization signal to the ECU (S43).

Next, controller 30c determines whether stopper 80 is unlocked or not (S47).

When controller 30c determines that stopper 80 is not unlocked (No in S47), it returns to step S41.

When controller 30c determines that stopper 80 is unlocked (Yes in S47), controller 30c causes alerter 70 to output an alert prompting storage of table 50 (S48). Controller 30c then returns to step S41.

Although this variation of the present embodiment presents an example in which vehicle steering apparatus 1c includes table 50, vehicle steering apparatus 1c is not required to include table 50.

### Other Variations

For example, in the embodiment, the lengths of the first portion and the second portion may be the same. In such cases, for example, short portion 12a is referred to as the first portion or second portion, and long portion 11a is referred to as second portion or the first portion.

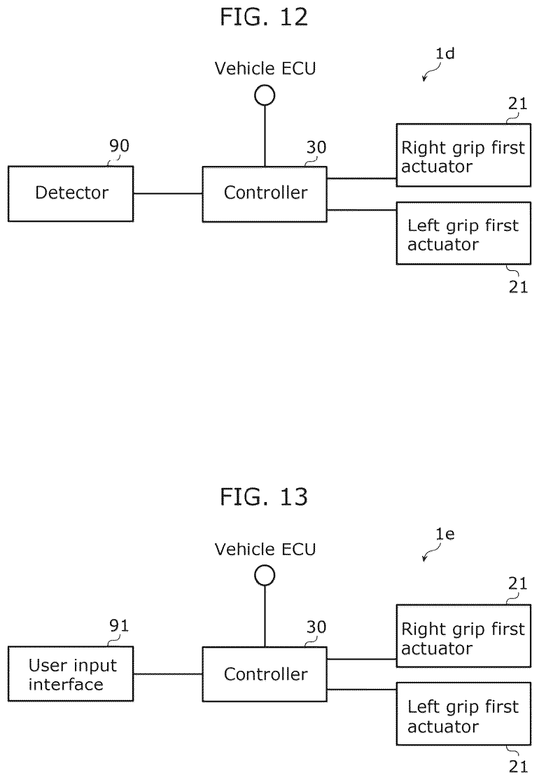

In the above embodiment, vehicle steering apparatus 1d may have the configuration illustrated in FIG. 12. FIG. 12 is a block diagram illustrating vehicle steering apparatus 1d according to another variation. Since vehicle steering apparatus 1d illustrated in FIG. 12 does not include second actuator 22 and stopper 80, vehicle steering apparatus 1d does not include table 50.

As illustrated in FIG. 12, vehicle steering apparatus 1d further includes detector 90 that detects coupling between a tongue of a seat belt provided in vehicle 3 and a buckle provided on the driver's seat. When detector 90 detects coupling between the tongue and the buckle, detector 90 outputs a signal indicating that the tongue and the buckle are coupled to controller 30. In such cases, as illustrated in (a) in FIG. 1, controller 30 controls the pair of first actuators 21 such that either long portions 11a or short portions 12a of the pair of grips 10 extend toward the ceiling of vehicle 3. Moreover, as illustrated in (a) in FIG. 7, controller 30b controls third actuator 23 so as to position connecting portion 13 of steering wheel 100 toward the floor of vehicle 3 relative to spoke 2.

When detector 90 detects that the tongue and the buckle have been decoupled, detector 90 outputs a signal indicating that the tongue and the buckle are decoupled to controller 30. In such cases, as illustrated in (b) in FIG. 1, controller 30 controls the pair of first actuators 21 such that long portions 11a of the pair of grips 10 extend toward the front of vehicle 3 and short portions 12a of the pair of grips 10 extend toward the rear of vehicle 3. Moreover, as illustrated in (b) in FIG. 7, controller 30b controls third actuator 23 so as to position connecting portion 13 of steering wheel 100 toward the front of vehicle 3 relative to spoke 2.

In the above embodiment, vehicle steering apparatus 1e may have the configuration illustrated in FIG. 13. FIG. 13 is another block diagram illustrating vehicle steering apparatus 1e according to another variation. Since vehicle steering apparatus 1e illustrated in FIG. 13 does not include second actuator 22 and stopper 80, vehicle steering apparatus 1e does not include table 50.

As illustrated in FIG. 13, vehicle steering apparatus 1e further includes user input interface 91 that the driver can operate to make an input. User input interface 91 is, for example, a capacitive touch pad. User input interface 91 is provided on the end face of short portion 12a on each grip 10. Note that user input interface 91 may be provided on either one of the pair of grips 10, and, alternatively, may be provided on both of the pair of grips 10.

### Advantageous Effects

Next, the advantageous effects achieved by vehicle steering apparatuses 1, 1a, 1b, 1c, 1d, and 1e according to the above embodiment, variations thereof, and other variations thereof, will be described.

The vehicle steering apparatus of PTL 1 has a problem in that a lateral movement mechanism must be provided to move the steering wheel from the operative position to the evasive position, resulting in a more complex structure around the steering wheel.

However, vehicle steering apparatuses 1, 1a, 1b, 1c, 1d, and 1e according to Technique 1 in the present embodiment and the like include: spoke 2 of a steering wheel of vehicle 3; and a pair of grips 10, one of which is disposed on the left portion of spoke 2 and another of which is disposed on the right portion of spoke 2, each shaped in an arc or straight line. The pair of grips 10 are rotatable relative to spoke 2.

This configuration allows the pair of grips 10 to rotatable relative to spoke 2, which makes it possible to expand the space in front of the driver sitting in the driver's seat by rotating the pair of grips 10. Accordingly, unlike the vehicle steering apparatus according to PTL 1 described above, there is no need to provide a lateral movement mechanism for laterally moving the steering wheel from in front of the driver's seat to in front of the passenger's seat.

This makes it possible to simplify the structure in the surrounding area of the steering wheel.

Vehicle steering apparatuses 1, 1a, 1d, and 1e according to Technique 2 in the present embodiment and the like are vehicle steering apparatuses 1, 1a, 1d, and 1e according to Technique 1, wherein the pair of grips 10 are separated and independently rotatable on the left portion and the right portion of spoke 2.

This makes it possible to freely adjust the orientations of each of left and right grips 10, thereby making it possible to adjust the size of the space in front of the driver sitting in the driver's seat.

Vehicle steering apparatuses 1, 1a, 1d, and 1e according to Technique 3 in the present embodiment and the like are vehicle steering apparatuses 1, 1a, 1d, and 1e according to Technique 1 or 2, wherein in each grip 10 in the pair of grips 10, when a steering position during driving of vehicle 3 by a driver is in a neutral position, the length of a first portion extending toward the ceiling of vehicle 3 relative to spoke 2 differs from the length of a second portion extending toward the floor of vehicle 3 relative to spoke 2.

With this, since the length of the first portion is different from the length of the second portion, for example, if short portions 12a are positioned to extend toward the driver, long portions 11a can be positioned to extend in the opposite direction, which increases the space between the driver and the steering wheel. In particular, positioning short portions 12a so as to extend toward the driver when parked makes it easier for the driver to enter and exit vehicle 3.

Vehicle steering apparatuses 1, 1a, 1d, and 1e according to Technique 4 in the present embodiment and the like are vehicle steering apparatuses 1, 1a, 1d, and 1e according to Technique 3, wherein each grip 10 in the pair of grips 10 is rotatable to an orientation in which short portion 12a is positioned toward the rear of vehicle 3 relative to spoke 2 and long portion 11a is positioned toward the front of vehicle 3 relative to spoke 2 when vehicle 3 is parked, short portion 12a being the shorter of the first portion and the second portion, long portion 11a being the longer of the first portion and the second portion.

With this, when parked, by rotating the pair of grips 10 so that long portions 11a are positioned toward the front of vehicle 3 relative to spoke 2 and short portions 12a are positioned toward the driver relative to spoke 2, the space around the driver's legs can be increased.

Vehicle steering apparatuses 1, 1a, 1d, and 1e according to Technique 5 in the present embodiment and the like are vehicle steering apparatuses 1, 1a, 1d, and 1e according to Technique 4, wherein the pair of grips 10 are independently rotatable, and grip 10 among the pair of grips 10 that is adjacent to door 9, of vehicle 3, that is adjacent to vehicle steering apparatus 1, 1a, 1d, or 1e, is placed in an orientation in which long portion 11a extends toward the ceiling of vehicle 3 and short portion 12a extends toward the floor of vehicle 3 when the driver enters or exits vehicle 3.

The space in front of the driver's seat of a vehicle is usually smaller than the space in front of the passenger's seat since a steering wheel is provided in front of the driver's seat. This makes getting in and out of the driver's seat more difficult compared to other seats.

However, according to the present embodiment and the like, the driver can get into and out of the driver's seat of vehicle 3 while holding long portion 11a of the grip adjacent to door 9 of vehicle 3. This makes it easier for the driver to get into and out of the driver's seat.

Vehicle steering apparatuses 1, 1d, and 1e according to Technique 6 in the present embodiment and the like are vehicle steering apparatuses 1, 1d, and 1e according to Technique 5, further including: the pair of grips 10; a pair of first actuators 21 that rotate the pair of grips 10; and controller 30 electrically connected to the pair of first actuators 21, wherein in each grip 10 in the pair of grips 10, when the steering position during driving of vehicle 3 is in the neutral position, the length of the first portion extending toward the ceiling of vehicle 3 relative to spoke 2 differs from the length of the second portion extending toward the floor of vehicle 3 relative to spoke 2, each grip 10 in the pair of grips 10 is rotatable to an orientation in which short portion 12a is positioned toward the rear of vehicle 3 relative to spoke 2 and long portion 11a is positioned toward the front of vehicle 3 relative to spoke 2 when vehicle 3 is parked, short portion 12a being the shorter of the first portion and the second portion, long portion 11a being the longer of the first portion and the second portion, controller 30: controls the pair of first actuators 21 to place each grip 10 in the pair of grips 10 in an orientation in which one of long portion 11a or short portion 12a extends toward the ceiling of vehicle 3 relative to spoke 2 when vehicle 3 is being driven manually, controls the pair of first actuators 21 to place each grip 10 in the pair of grips 10 in an orientation in which short portion 12a extends toward the rear of vehicle 3 relative to spoke 2 and long portion 11a extends toward the front of vehicle 3 relative to spoke 2 when vehicle 3 is parked or vehicle 3 is driving autonomously, and controls the pair of first actuators 21 to place grip 10 that is adjacent to door 9 adjacent to vehicle steering apparatus 1, 1d, or 1e in an orientation in which long portion 11a extends toward the ceiling of vehicle 3 relative to spoke 2 and short portion 12a extends toward the floor of vehicle 3 relative to spoke 2 when the driver enters or exits vehicle 3.

With this, since the rotational positions of grips 10 automatically change according to the state of vehicle 3, such as during driving, while parked, or while a driver is entering or exiting vehicle 3, there is no need for the driver to take any special measures to rotate the pair of grips 10. This improves convenience for the driver.

Vehicle steering apparatuses 1, 1a, 1d, and 1e according to Technique 7 in the present embodiment and the like are vehicle steering apparatuses 1, 1a, 1d, and 1e according to Technique 6, further including: table 50 storable in a storage space in column cover 6 that covers a bottom of steering column 4; and second actuator 22 that actuates table 50 to move table 50 from steering column 4 toward the rear of vehicle 3, and actuates table 50 to move table 50 toward the front of vehicle 3 to store table 50 in column cover 6, wherein controller 30, 30a: controls second actuator 22 to move table 50 from steering column 4 toward the rear of vehicle 3 when vehicle 3 is parked; and controls second actuator 22 to move table 50 toward the front of vehicle 3 to store table 50 in the storage space in column cover 6 during driving or when the driver enters or exits vehicle 3.

With this, when vehicle 3 is parked, table 50 automatically deploys to a position in front of the driver. Therefore, there is no need for the driver to take any special measures to use table 50. This improves convenience for the driver.

Vehicle steering apparatuses 1a, 1d, and 1e according to Technique 8 in the present embodiment and the like are vehicle steering apparatuses 1a, 1d, and 1e according to Technique 5, further including: a pair of position sensors 60 that detect rotational positions of the pair of grips 10; and controller 30, 30a electrically connected to the pair of position sensors 60, wherein each of the pair of grips 10 is manually rotatable, and controller 30, 30a: is electrically connected to the pair of position sensors 60; outputs a ready-to-drive signal when controller 30, 30a determines, based on the rotational positions of the pair of grips 10 detected by the pair of position sensors 60, that each grip 10 in the pair of grips 10 is in an orientation in which one of long portion 11a or short portion 12a extends toward the ceiling of vehicle 3 relative to spoke 2; outputs a parked signal when controller 30, 30a determines, based on the rotational positions of the pair of grips 10 detected by the pair of position sensors 60, that each grip 10 in the pair of grips 10 is in an orientation in which short portion 12a extends toward the rear of vehicle 3 relative to spoke 2 and long portion 11a extends toward the front of vehicle 3 relative to spoke 2; and outputs a door unlock authorization signal when controller 30, 30a determines, based on the rotational positions of the pair of grips 10 detected by the pair of position sensors 60, that grip 10 that is adjacent to door 9 adjacent to vehicle steering apparatus 1a, 1d, or 1e is in an orientation in which long portion 11a extends toward the ceiling of vehicle 3 relative to spoke 2 and short portion 12a extends toward the floor of vehicle 3 relative to spoke 2.

With this, various signals are output to the ECU according to the position of the grips, so the ECU can control vehicle 3 appropriately according to the signals.

Vehicle steering apparatuses 1a, 1d, and 1e according to Technique 9 in the present embodiment and the like are vehicle steering apparatuses 1, 1a, 1d, and 1e according to Technique 8, further including: table 50 storable in a storage space in column cover 6 that covers a bottom of steering column 4 and is manually deployable; and stopper 80 that is electrically connected to controller 30, 30a and restricts movement of table 50, wherein controller 30, 30a unlocks stopper 80 when the parked signal is output.

With this, since table 50 is permitted to deploy only when vehicle 3 is parked, a reduction in safety while vehicle 3 is driving can be inhibited, and an improvement in convenience in regard to usage of table 50 only while parked can be achieved.

Vehicle steering apparatuses 1a, 1d, and 1e according to Technique 10 in the present embodiment and the like are vehicle steering apparatuses 1a, 1d, and 1e according to Technique 9, wherein if stopper 80 is unlocked when controller 30, 30a outputs the ready-to-drive signal or the door unlock authorization signal, controller 30, 30a causes alerter 70 to output an alert prompting storage of table 50.

With this, the driver can be alerted if table 50 is deployed from the storage space in column cover 6 when starting to drive and when starting to enter or exit vehicle 3. This makes it possible to prompt the driver to store table 50 in the storage space in column cover 6. This consequently inhibits a reduction in safety when driving vehicle 3 and when entering or exiting vehicle 3.

Vehicle steering apparatuses 1b, 1c, 1d, and 1e according to Technique 11 in the present embodiment and the like are vehicle steering apparatuses 1b, 1c, 1d, and 1e according to Technique 1, wherein the pair of grips 10 are configured as steering wheel 100 characterized by one of corresponding ends of the pair of grips 10 being integrally connected. Steering wheel 100 is rotatable to position connecting portion 13 of steering wheel 100 connecting the pair of grips 10 toward the front of vehicle 3 relative to spoke 2 when vehicle 3 is parked.

With this, when parked, by rotating steering wheel 100 so that connecting portion 13 is positioned toward the front of vehicle 3 relative to spoke 2 and short portions 12a, which are on the opposite side relative to connecting portion 13, are positioned toward the driver relative to spoke 2, the space around the driver's legs can be increased.

Vehicle steering apparatuses 1b, 1c, 1d, and 1e according to Technique 12 in the present embodiment and the like are vehicle steering apparatuses 1b, 1c, 1d, and 1e according to Technique 11, wherein when a driver enters or exits vehicle 3, connecting portion 13 of steering wheel 100 is positioned toward the ceiling of vehicle 3 relative to spoke 2.

The space in front of the driver's seat of vehicle 3 is usually smaller than the space in front of the passenger's seat since a steering wheel is provided in front of the driver's seat. This makes getting in and out of the driver's seat more difficult compared to other seats.

However, according to the present embodiment and the like, the driver can get into and out of the driver's seat of vehicle 3 while holding connecting portion 13 of vehicle 3. This makes it easier for the driver to get into and out of the driver's seat.

Vehicle steering apparatuses 1b, 1d, and 1e according to Technique 13 in the present embodiment and the like are vehicle steering apparatuses 1b, 1d, and 1e according to Technique 12, further including: third actuator 23 that rotates steering wheel 100; and controller 30, 30b electrically connected to third actuator 23. Controller 30, 30b: controls third actuator 23 to position connecting portion 13 of steering wheel 100 toward the floor of vehicle 3 relative to spoke 2 when the driver is manually driving vehicle 3; controls third actuator 23 to position connecting portion 13 of steering wheel 100 toward the front of vehicle 3 relative to spoke 2 when vehicle 3 is parked or vehicle 3 is driving autonomously; and controls third actuator 23 to position connecting portion 13 of steering wheel 100 toward the ceiling of vehicle 3 relative to spoke 2 when the driver enters or exits vehicle 3.

With this, since the rotational position of steering wheel 100 automatically changes according to the state of vehicle 3, such as during driving, while parked, or while a driver is entering or exiting vehicle 3, there is no need for the driver to take any special measures to rotate steering wheel 100. This improves convenience for the driver.

Vehicle steering apparatuses 1b, 1d, and 1e according to Technique 14 in the present embodiment and the like are vehicle steering apparatuses 1b, 1d, and 1e according to Technique 13, further including: table 50 storable in a storage space in column cover 6 that covers a bottom of steering column 4; and fourth actuator 24 that actuates table 50 to move table 50 from steering column 4 toward the rear of vehicle 3, and actuates table 50 to move table 50 toward the front of vehicle 3 to store table 50 in column cover 6, wherein controller 30, 30b: controls fourth actuator 24 to move table 50 from steering column 4 toward the rear of vehicle 3 when vehicle 3 is parked; and controls fourth actuator 24 to move table 50 toward the front of vehicle 3 to store table 50 in the storage space in column cover 6 during driving or when the driver enters or exits vehicle 3.

With this, when vehicle 3 is parked, table 50 automatically deploys to a position in front of the driver. Therefore, there is no need for the driver to take any special measures to use table 50. This improves convenience for the driver.

Vehicle steering apparatuses 1c, 1d, and 1e according to Technique 15 in the present embodiment and the like are vehicle steering apparatuses 1c, 1d, and 1e according to Technique 12, further including: position sensor 60 that detects a rotational position of steering wheel 100; and controller 30, 30c electrically connected to position sensor 60, wherein steering wheel 100 is manually rotatable, and controller 30, 30c: is electrically connected to position sensor 60; outputs a ready-to-drive signal when controller 30, 30c determines, based on the rotational position of steering wheel 100 detected by position sensor 60, that steering wheel 100 is in an orientation in which connecting portion 13 is positioned toward the floor of vehicle 3 relative to spoke 2; outputs a parked signal when controller 30, 30c determines, based on the rotational position of steering wheel 100 detected by position sensor 60, that steering wheel 100 is in an orientation in which connecting portion 13 is positioned toward the front of vehicle 3 relative to spoke 2; and outputs a door unlock authorization signal when controller 30, 30c determines, based on the rotational position of steering wheel 100 detected by position sensor 60, that steering wheel 100 is in an orientation in which connecting portion 13 is positioned toward the ceiling of vehicle 3 relative to spoke 2.

With this, various signals are output to the ECU according to the position of steering wheel 100, so the ECU can control vehicle 3 appropriately according to the signals.

Vehicle steering apparatuses 1c, 1d, and 1e according to Technique 16 in the present embodiment and the like are vehicle steering apparatuses 1c, 1d, and 1e according to Technique 15, further including: table 50 storable in a storage space in column cover 6 that covers a bottom of steering column 4 and is manually deployable; and stopper 80 that is electrically connected to controller 30, 30c and restricts movement of table 50, wherein controller 30, 30c unlocks stopper 80 when the parked signal is output.

With this, since table 50 is permitted to deploy only when vehicle 3 is parked, a reduction in safety while vehicle 3 is driving can be inhibited, and an improvement in convenience in regard to usage of table 50 only while parked can be achieved.

Vehicle steering apparatuses 1c, 1d, and 1e according to Technique 17 in the present embodiment and the like are vehicle steering apparatuses 1c, 1d, and 1e according to Technique 16, wherein if stopper 80 is unlocked when controller 30, 30c outputs the ready-to-drive signal or the door unlock authorization signal, controller 30, 30c causes alerter 70 to output an alert prompting storage of table 50.

With this, the driver can be alerted if table 50 is deployed from the storage space in column cover 6 when starting to drive and when starting to enter or exit vehicle 3. This makes it possible to prompt the driver to store table 50 in the storage space in column cover 6. This consequently inhibits a reduction in safety when driving vehicle 3 and when entering or exiting vehicle 3.

Vehicle steering apparatuses 1, 1a, 1b, 1c, 1d, and 1e according to Technique 18 in the present embodiment and the like are vehicle steering apparatuses 1, 1a, 1b, 1c, 1d, and 1e according to any one of Techniques 7, 9, 14, and 16, wherein table 50 further includes input interface 51.

This makes it easy to operate a display on table 50 in vehicle 3.

Vehicle steering apparatuses 1, 1a, 1b, 1c, 1d, and 1e according to Technique 19 in the present embodiment and the like are vehicle steering apparatuses 1, 1a, 1b, 1c, 1d, and 1e according to Technique 18, wherein input interface 51 is a touch pad, a touch panel, or a projection keyboard.

With this, the driver can use input interface 51 on table 50 to make an input, and the flat top surface table 50 can be used as a table when input interface 51 is not being used.

Vehicle steering apparatuses 1, 1a, 1d, and 1e according to Technique 20 in the present embodiment and the like are vehicle steering apparatuses 1, 1a, 1d, and 1e according to Technique 6 or 7, further including: detector 90 that detects coupling between a tongue of a seat belt provided in vehicle 3 and a buckle provided for a seat of the driver, detector 90 being electrically connected to controller 30, 30a, wherein each grip 10 in the pair of grips 10 includes long portion 11a and short portion 12a, long portion 11a being longer than short portion 12a, short portion 12a being shorter than long portion 11a, when detector 90 detects the coupling between the tongue and the buckle, controller 30, 30a controls the pair of first actuators 21 to place each grip 10 in the pair of grips 10 in an orientation in which one of long portion 11a or short portion 12a extends toward the ceiling of vehicle 3 relative to spoke 2, and when detector 90 detects decoupling between the tongue and the buckle, controller 30, 30a controls the pair of first actuators 21 to place each grip 10 in the pair of grips 10 in an orientation in which long portion 11a extends toward the front of vehicle 3 relative to spoke 2 and short portion 12a extends toward the rear of vehicle 3 relative to spoke 2.

With this, since vehicle 3 cannot be driven unless the driver and other passengers buckle their seatbelts, it is possible to force the driver and other passengers to buckle their seatbelts.

Vehicle steering apparatuses 1b, 1c, 1d, and 1e according to Technique 21 in the present embodiment and the like are vehicle steering apparatuses 1b, 1c, 1d, and 1e according to Technique 13 or 14, further including: detector 90 that detects coupling between a tongue of a seat belt provided in vehicle 3 and a buckle provided for a seat of the driver, detector 90 being electrically connected to controller 30, 30b, wherein when detector 90 detects the coupling between the tongue and the buckle, controller 30, 30b controls third actuator 23 to place steering wheel 100 in an orientation in which connecting portion 13 is positioned toward the floor of vehicle 3 relative to spoke 2, and when detector 90 detects decoupling between the tongue and the buckle, controller 30, 30b controls third actuator 23 to place steering wheel 100 in an orientation in which connecting portion 13 is positioned toward the front of vehicle 3 relative to spoke 2.

With this, since vehicle 3 cannot be driven unless the driver and other passengers buckle their seatbelts, it is possible to force the driver and other passengers to buckle their seatbelts.

Vehicle steering apparatuses 1, 1a, 1b, 1c, 1d, and 1e according to Technique 22 in the present embodiment and the like are vehicle steering apparatuses 1, 1a, 1b, 1c, 1d, and 1e according to any one of Techniques 1 to 21, further including: user input interface 91, provided on at least one end portion of the pair of grips 10 (steering wheel 100), operable by a driver to make an input.

With this, the driver can make an input via the user input interface while holding the pair of grips 10 (steering wheel 100). This improves operability of in-vehicle devices for the driver.

In particular, when user input interface 91 is provided on the end portion of short portion 12a, the driver can operate user input interface 91 on short portion 12a using their fingers while holding the grip. User input interface 91 is, for example, a capacitive touch pad.

If vehicle 3 is parked or autonomously driving, in addition to in-vehicle devices, devices operable via user input interface 91 may include, for example, a smartphone or gaming device communicably connected to controller 30, 30a, 30b, or 30c.

### OTHER REMARKS

Hereinbefore, the vehicle steering apparatus according to the present disclosure has been described based on the above embodiment, variations thereof, and other variations thereof, but the present disclosure is not limited to these. Various modifications to the embodiment, etc., that may be conceived by those skilled in the art are also intended to be included within the scope of the present disclosure as long as they do not depart from the essence of the present disclosure.

In the above embodiment, variations thereof, and other variations thereof, all or part of the elements such as the controller may be configured using dedicated hardware, or may be implemented by executing a software program suitable for each element. Each element may be implemented by a program execution unit such as a central processing unit (CPU) or processor reading and executing a software program recorded on a recording medium such as a hard disk drive (HDD) or semiconductor memory.

Moreover, the division of the function blocks in the block diagrams are mere examples. A plurality of function blocks may be realized as a single function block, a single function block may be divided into a plurality of function blocks, or a portion of functions of one block may be transferred to a different function block. A plurality of function blocks which share similar functions can be processed by standalone hardware or software in parallel or time-shared.

The order in which the steps are executed in the flow charts are mere examples presented for illustrative purposes; the steps may be executed in a different order. Moreover, some of the steps may be executed at the same time as (in parallel with) other steps.

Embodiments arrived at by a person skilled in the art making various modifications to any one of the above embodiment, variations thereof, and other variations thereof, as well as embodiments realized by arbitrarily combining elements and functions in the above embodiment, variations thereof, and other variations thereof, which do not depart from the essence of the present disclosure are included in the present disclosure.

### FURTHER INFORMATION ABOUT TECHNICAL BACKGROUND TO THIS APPLICATION

The disclosures of the following patent applications including specification, drawings and claims are incorporated herein by reference in their entirety: Japanese Patent Application No. 2023-207029 filed on Dec. 7, 2023.

### INDUSTRIAL APPLICABILITY

The vehicle steering apparatus according to the present disclosure is applicable to steering wheels in vehicles.

1. A vehicle steering apparatus comprising:
a spoke of a steering wheel of a vehicle; and
a pair of grips, one of which is disposed on a left portion of the spoke and another of which is disposed on a right portion of the spoke, each shaped in an arc or straight line, wherein
the pair of grips are rotatable relative to the spoke.

2. The vehicle steering apparatus according to claim 1, wherein
the pair of grips are separated and independently rotatable on the left portion and the right portion of the spoke.

3. The vehicle steering apparatus according to claim 2, wherein
in each grip in the pair of grips, when a steering position during driving of the vehicle by a driver is in a neutral position, a length of a first portion extending toward a ceiling of the vehicle relative to the spoke differs from a length of a second portion extending toward a floor of the vehicle relative to the spoke.

4. The vehicle steering apparatus according to claim 3, wherein
each grip in the pair of grips is rotatable to an orientation in which a short portion is positioned toward a rear of the vehicle relative to the spoke and a long portion is positioned toward a front of the vehicle relative to the spoke when the vehicle is parked, the short portion being a shorter of the first portion and the second portion, the long portion being a longer of the first portion and the second portion.

5. The vehicle steering apparatus according to claim 4, wherein
the pair of grips are independently rotatable, and
a grip among the pair of grips that is adjacent to a door, of the vehicle, that is adjacent to the vehicle steering apparatus, is placed in an orientation in which the long portion extends toward the ceiling of the vehicle and the short portion extends toward the floor of the vehicle when the driver enters or exits the vehicle.

6. The vehicle steering apparatus according to claim 5, further comprising:
the pair of grips;
a pair of first actuators that rotate the pair of grips; and
a controller electrically connected to the pair of first actuators, wherein
in each grip in the pair of grips, when the steering position during driving of the vehicle is in the neutral position, the length of the first portion extending toward the ceiling of the vehicle relative to the spoke differs from the length of the second portion extending toward the floor of the vehicle relative to the spoke,
each grip in the pair of grips is rotatable to an orientation in which the short portion is positioned toward the rear of the vehicle relative to the spoke and the long portion is positioned toward the front of the vehicle relative to the spoke when the vehicle is parked, the short portion being the shorter of the first portion and the second portion, the long portion being the longer of the first portion and the second portion, and
the controller:
controls the pair of first actuators to place each grip in the pair of grips in an orientation in which one of the long portion or the short portion extends toward the ceiling of the vehicle relative to the spoke when the vehicle is being driven manually,
controls the pair of first actuators to place each grip in the pair of grips in an orientation in which the short portion extends toward the rear of the vehicle relative to the spoke and the long portion extends toward the front of the vehicle relative to the spoke when the vehicle is parked or the vehicle is driving autonomously, and
controls the pair of first actuators to place the grip that is adjacent to the door adjacent to the vehicle steering apparatus in an orientation in which the long portion extends toward the ceiling of the vehicle relative to the spoke and the short portion extends toward the floor of the vehicle relative to the spoke when the driver enters or exits the vehicle.

7. The vehicle steering apparatus according to claim 6, further comprising:
a table storable in a column cover that covers a bottom of a steering column; and
a second actuator that actuates the table to move the table from the steering column toward the rear of the vehicle, and actuates the table to move the table toward the front of the vehicle to store the table in the column cover, wherein
the controller:
controls the second actuator to move the table from the steering column toward the rear of the vehicle when the vehicle is parked; and
controls the second actuator to move the table toward the front of the vehicle to store the table in the column cover during driving or when the driver enters or exits the vehicle.

8. The vehicle steering apparatus according to claim 5, further comprising:
a pair of position sensors that detect rotational positions of the pair of grips; and
a controller electrically connected to the pair of position sensors, wherein
each of the pair of grips is manually rotatable, and
the controller:
is electrically connected to the pair of position sensors;
outputs a ready-to-drive signal when the controller determines, based on the rotational positions of the pair of grips detected by the pair of position sensors, that each grip in the pair of grips is in an orientation in which one of the long portion or the short portion extends toward the ceiling of the vehicle relative to the spoke;
outputs a parked signal when the controller determines, based on the rotational positions of the pair of grips detected by the pair of position sensors, that each grip in the pair of grips is in an orientation in which the short portion extends toward the rear of the vehicle relative to the spoke and the long portion extends toward the front of the vehicle relative to the spoke; and
outputs a door unlock authorization signal when the controller determines, based on the rotational positions of the pair of grips detected by the pair of position sensors, that the grip that is adjacent to the door adjacent to the vehicle steering apparatus is in an orientation in which the long portion extends toward the ceiling of the vehicle relative to the spoke and the short portion extends toward the floor of the vehicle relative to the spoke.

9. The vehicle steering apparatus according to claim 8, further comprising:
a table storable in a column cover that covers a bottom of a steering column and is manually deployable; and
a stopper that is electrically connected to the controller and restricts movement of the table, wherein
the controller unlocks the stopper when the parked signal is output.

10. The vehicle steering apparatus according to claim 9, wherein
if the stopper is unlocked when the controller outputs the ready-to-drive signal or the door unlock authorization signal, the controller causes an alerter to output an alert prompting storage of the table.

11. The vehicle steering apparatus according to claim 1, wherein
the pair of grips are configured as a steering wheel characterized by one of corresponding ends of the pair of grips being integrally connected, and
the steering wheel is rotatable to position a connecting portion of the steering wheel connecting the pair of grips toward a front of the vehicle relative to the spoke when the vehicle is parked.

12. The vehicle steering apparatus according to claim 11, wherein
when a driver enters or exits the vehicle, the connecting portion of the steering wheel is positioned toward a ceiling of the vehicle relative to the spoke.

13. The vehicle steering apparatus according to claim 12, further comprising:
a third actuator that rotates the steering wheel; and
a controller electrically connected to the third actuator, wherein
the controller:
controls the third actuator to position the connecting portion of the steering wheel toward a floor of the vehicle relative to the spoke when the driver is manually driving the vehicle;
controls the third actuator to position the connecting portion of the steering wheel toward a front of the vehicle relative to the spoke when the vehicle is parked or the vehicle is driving autonomously; and
controls the third actuator to position the connecting portion of the steering wheel toward a ceiling of the vehicle relative to the spoke when the driver enters or exits the vehicle.

14. The vehicle steering apparatus according to claim 13, further comprising:
a table storable in a column cover that covers a bottom of a steering column; and
a fourth actuator that actuates the table to move the table from the steering column toward a rear of the vehicle, and actuates the table to move the table toward the front of the vehicle to store the table in the column cover, wherein
the controller:
controls the fourth actuator to move the table from the steering column toward the rear of the vehicle when the vehicle is parked; and
controls the fourth actuator to move the table toward the front of the vehicle to store the table in the column cover during driving or when the driver enters or exits the vehicle.

15. The vehicle steering apparatus according to claim 12, further comprising:
a position sensor that detects a rotational position of the steering wheel; and
a controller electrically connected to the position sensor, wherein
the steering wheel is manually rotatable, and
the controller:
is electrically connected to the position sensor;
outputs a ready-to-drive signal when the controller determines, based on the rotational position of the steering wheel detected by the position sensor, that the steering wheel is in an orientation in which the connecting portion is positioned toward a floor of the vehicle relative to the spoke;
outputs a parked signal when the controller determines, based on the rotational position of the steering wheel detected by the position sensor, that the steering wheel is in an orientation in which the connecting portion is positioned toward the front of the vehicle relative to the spoke; and
outputs a door unlock authorization signal when the controller determines, based on the rotational position of the steering wheel detected by the position sensor, that the steering wheel is in an orientation in which the connecting portion is positioned toward the ceiling of the vehicle relative to the spoke.

16. The vehicle steering apparatus according to claim 15, further comprising:
a table storable in a column cover that covers a bottom of a steering column and is manually deployable; and
a stopper that is electrically connected to the controller and restricts movement of the table, wherein
the controller unlocks the stopper when the parked signal is output.

17. The vehicle steering apparatus according to claim 7, wherein
the table further includes an input interface.

18. The vehicle steering apparatus according to claim 6, further comprising:
a detector that detects coupling between a tongue of a seat belt provided in the vehicle and a buckle provided for a seat of the driver, the detector being electrically connected to the controller, wherein
each grip in the pair of grips includes the long portion and the short portion, the long portion being longer than the short portion, the short portion being shorter than the long portion,
when the detector detects the coupling between the tongue and the buckle, the controller controls the pair of first actuators to place each grip in the pair of grips in an orientation in which one of the long portion or the short portion extends toward the ceiling of the vehicle relative to the spoke, and
when the detector detects decoupling between the tongue and the buckle, the controller controls the pair of first actuators to place each grip in the pair of grips in an orientation in which the long portion extends toward the front of the vehicle relative to the spoke and the short portion extends toward the rear of the vehicle relative to the spoke.

19. The vehicle steering apparatus according to claim 13, further comprising:
a detector that detects coupling between a tongue of a seat belt provided in the vehicle and a buckle provided for a seat of the driver, the detector being electrically connected to the controller, wherein
when the detector detects the coupling between the tongue and the buckle, the controller controls the third actuator to place the steering wheel in an orientation in which the connecting portion is positioned toward the floor of the vehicle relative to the spoke, and
when the detector detects decoupling between the tongue and the buckle, the controller controls the third actuator to place the steering wheel in an orientation in which the connecting portion is positioned toward the front of the vehicle relative to the spoke.

20. The vehicle steering apparatus according to claim 1, further comprising:
a user input interface, provided on at least one end portion of the pair of grips, operable by a driver to make an input.
